(19) United States
(12) Patent Application Publication
(10) Pub. No.: US 2026/0241703 A1
(43) Pub. Date: Aug. 20, 2026

(54) LIQUID DISCHARGE HEAD AND RECORDING DEVICE

(71) Applicant: KYOCERA Corporation, Kyoto (JP)

(72) Inventors: Takumi MORIMURA, Uji-shi, Kyoto (JP); Keita HIRAI, Moriyama-shi, Shiga (JP)

(21) Appl. No.: 19/156,403

(22) PCT Filed: Feb. 15, 2024
(86) PCT No.: PCT/JP2024/005362

§ 371 Date: Aug. 14, 2025

(30) Foreign Application Priority Data
Feb. 15, 2023 (JP) 2023-021784

(51) Int. Cl. B41J 2/21; B41J 25/00

(52) U.S. Cl. CPC B41J 2/2103; B41J 25/005

(57) ABSTRACT

A liquid discharge head includes nozzles in a region of 2m rows×n columns. Each nozzle can discharge a liquid of one color among liquids of m types of colors. Two columns adjacent in a row direction are defined as pixel columns, any one pixel column is regarded as a first pixel column, the other pixel column is regarded as a second pixel column, and each of the first pixel column and the second pixel column can discharge the liquids of m types of colors from m pieces of the nozzles. When viewed from an outward path direction, the order of colors of the liquids dischargeable from the m pieces of the nozzles included in the first pixel column is opposite to the order of colors of the liquids that can be discharged from the m pieces of the nozzles included in the second pixel column.

### CROSS-REFERENCE TO RELATED APPLICATIONS

This application is national stage application of International Application No. PCT/JP2024/005362, filed on Feb. 15, 2024 which designates the United States, and which claims the benefit of priority from Japanese Patent Application No. 2023-021784, filed on Feb. 15, 2023.

### TECHNICAL FIELD

The present disclosure relates to a liquid discharge head and a recording device.

### BACKGROUND OF INVENTION

A so-called serial type printer in which printing is performed by discharging a liquid from a nozzle while a liquid discharge head reciprocates is known (for example, see Patent Document 1). When a matrix-shaped region is assumed at a nozzle surface, the liquid discharge head includes a plurality of nozzles provided at predetermined locations in the region, and four nozzles are provided in each column. The four nozzles can discharge liquids of four colors, and the liquids are discharged to respective pixel regions on a recording medium.

### CITATION LIST

### Patent Literature

Patent Document 1: JP 2015-54453 A

### SUMMARY

A liquid discharge head according to an aspect of the present disclosure includes a plurality of nozzles provided at predetermined locations in a region of a nozzle surface, the region being assumed to be a matrix-shaped region of 2m rows×n columns (m is an even number of 2 or more, and n is an integer of 4 or more), and performs printing on a recording medium by reciprocating in a direction intersecting a row direction while discharging liquids from the plurality of nozzles in an outward path and a homeward path. Each of the plurality of nozzles is configured to discharge a liquid of one color selected from among the liquids of m types of colors, and each of the plurality of nozzles configured to discharge the liquids of the same color is provided in a respective one of the 2m rows. Each of the n columns is provided with m/2 pieces of nozzles. When respective two of the columns adjacent to each other in the row direction are defined as pixel columns, any one of the pixel columns is regarded as a first pixel column, and another of the pixel columns adjacent to the first pixel column in the row direction is regarded as a second pixel column, then each of the first pixel column and the second pixel column is configured to discharge the liquids of m types of colors from m pieces of the plurality of nozzles. When viewed from a direction of the outward path, an order of colors of the liquids dischargeable from the m pieces of the plurality of nozzles included in the first pixel column is opposite to an order of colors of the liquids dischargeable from the m pieces of the plurality of nozzles included in the second pixel column.

### BRIEF DESCRIPTION OF THE DRAWINGS

FIG. 1 is a side view schematically illustrating a printer according to a first embodiment.

FIG. 2 is a plan view schematically illustrating the printer according to the first embodiment.

FIG. 3 is a schematic diagram for explaining a serial printing method executed by the printer according to the first embodiment.

FIG. 4 is a plan view schematically illustrating a liquid discharge head according to the first embodiment.

FIG. 5 is a side view of the liquid discharge head illustrated in FIG. 4, as seen from a direction A.

FIG. 6 is a plan view illustrating a nozzle surface according to the first embodiment.

FIG. 7 is a schematic cross-sectional view illustrating a part of the liquid discharge head according to the first embodiment in an enlarged manner.

FIG. 8 is an enlarged view of a region I illustrated in FIG. 6.

FIG. 9 is a plan view schematically illustrating liquids discharged to adjacent pixel regions on a printing paper by a first comparative head.

FIG. 10 is a plan view schematically illustrating liquids discharged to adjacent pixel regions on a printing paper by the liquid discharge head according to the first embodiment.

FIG. 11 is a schematic diagram illustrating a state of liquids discharged onto a printing paper in an outward path and a homeward path by a second comparative head.

FIG. 12 is a schematic diagram illustrating a state of liquids discharged onto a printing paper in an outward path and a homeward path by the liquid discharge head according to the first embodiment.

FIG. 13 is an enlarged view of the region I illustrated in FIG. 6.

FIG. 14 is a plan view schematically illustrating liquids discharged onto a printing paper by the liquid discharge head according to the first embodiment.

FIG. 15 is an enlarged view of the region I illustrated in FIG. 6.

FIG. 16 is a plan view of liquids discharged onto a printing paper P.

FIG. 17 is a plan view illustrating another example of the nozzle surface according to the first embodiment.

FIG. 18 is an enlarged view of the region I illustrated in FIG. 6.

FIG. 19 is a plan view illustrating a part of a nozzle surface according to a second embodiment in an enlarged manner.

FIG. 20 is a plan view illustrating a part of a nozzle surface according to a third embodiment in an enlarged manner.

### DESCRIPTION OF EMBODIMENTS

In the above-described liquid discharge head, there is a possibility that streaks occur because the liquids discharged to the adjacent pixel regions on the recording medium do not overlap. In the above-described liquid discharge head, the order in which the colors of the liquids overlap are reversed between the outward path and the homeward path, and thus there is a possibility that color unevenness occurs.

The possibility of occurrence of streaks and color unevenness are expected to be reduced.

Embodiments of the present invention will be described below with reference to the drawings.

Note that drawings used in the following description are schematic, and dimensional ratios and the like on the drawings do not always match the actual ones. In multiple drawings illustrating the same configuration, dimensional ratios and the like may not match each other in order to exaggerate shapes or the like.

### First Embodiment

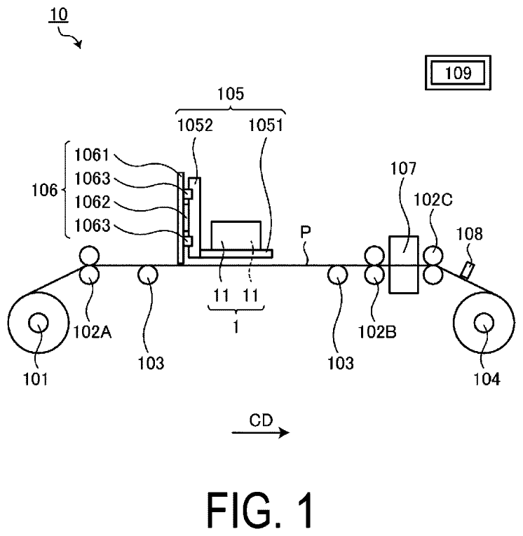

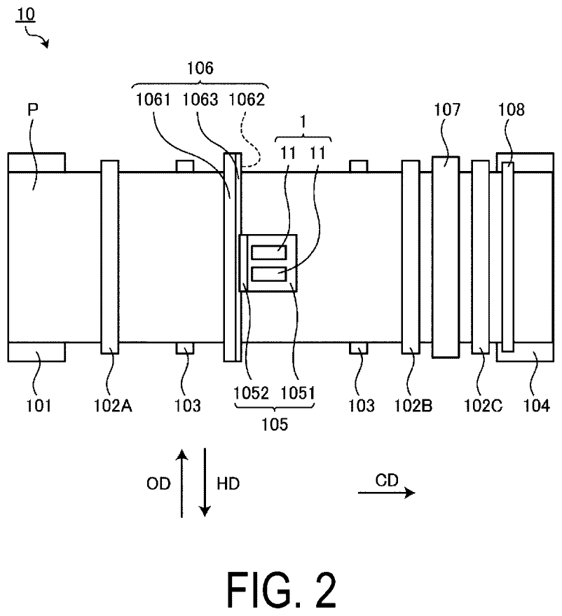

A configuration of a printer 10 according to the present embodiment will be described with reference to FIGS. 1 and 2.

FIG. 1 is a side view schematically illustrating the printer 10 according to a first embodiment. FIG. 2 is a plan view schematically illustrating the printer 10 according to the first embodiment. The printer 10 includes a liquid discharge head 1. The printer 10 is, for example, a color inkjet printer.

As illustrated in FIG. 1, the printer 10 includes a paper feed roller 101, guide rollers 102A to 102C, conveyance rollers 103, a collection roller 104, a frame 105, the liquid discharge head 1, a scanner 106, a dryer 107, a sensor 108, and a controller 109.

The controller 109 controls operations of the paper feed roller 101, the guide rollers 102A to 102C, the conveyance rollers 103, the collection roller 104, the frame 105, the liquid discharge head 1, the scanner 106, the dryer 107, and the sensor 108.

The paper feed roller 101, the guide rollers 102A to 102C, the conveyance rollers 103, and the collection roller 104 constitute a moving unit that relatively moves a printing paper P and the liquid discharge head 1. The printing paper P is an example of a recording medium. The moving unit is controlled by the controller 109. The printing paper P passes between two guide rollers 102A from the paper feed roller 101 and is conveyed onto the conveyance rollers 103. Thereafter, the printing paper P passes between two guide rollers 102B and between two guide rollers 102C and is conveyed to the collection roller 104. A rightward direction in the drawing is a conveying direction CD of the printing paper P.

The frame 105 is located in an upward direction in the drawing so as to be in close proximity to the printing paper P conveyed by the conveyance rollers 103. The frame 105 includes a head support frame 1051 and a back frame 1052. The head support frame 1051 is a horizontal plate for holding the liquid discharge head 1. The back frame 1052 is a vertical plate extending in the upward direction from a left end of the head support frame 1051 in the drawing.

The liquid discharge head 1 is mounted to the frame 105 and is located on the head support frame 1051. The liquid discharge head 1 includes two heads 11. The two heads 11 are arranged in a vertical direction in the drawing in FIG. 2. The head support frame 1051 is provided with openings at the arrangement locations of the heads 11, respectively. The heads 11 are fitted into the openings and incorporated in the head support frame 1051.

The controller 109 controls the liquid discharge head 1 based on data of an image or characters to discharge liquids toward the printing paper P. A distance between the liquid discharge head 1 and the printing paper P is, for example, about 0.5 to 20 mm.

The scanner 106 is located above the printing paper P conveyed by the conveyance rollers 103. The scanner 106 includes a head guide 1061, a timing belt 1062, and guide rails 1063. The scanner 106 has a function of reciprocating the liquid discharge head 1 mounted on the frame 105 in the vertical direction in the drawing in FIG. 2. The vertical direction in FIG. 2 is a reciprocating direction of the liquid discharge head 1, the upward direction in the drawing is an outward path direction OD of the liquid discharge head 1, and a downward direction in the drawing is a homeward path direction HD of the liquid discharge head 1.

The head guide 1061 is a flat plate-shaped member that is long in the reciprocating direction, and is located at the left end of the scanner 106 in the drawing. The timing belt 1062 is assembled to the head guide 1061. The timing belt 1062 is an endless belt and is capable of moving in a circulating manner in the outward path direction OD and the homeward path direction HD. The frame 105 on which the liquid discharge head 1 is mounted is fixed to the timing belt 1062. The guide rails 1063 are located above and below the timing belt 1062 in the head guide 1061. The pair of upper and lower guide rails 1063 are disposed so as to extend in the reciprocating direction, and hold the frame 105 on which the liquid discharge head 1 is mounted in a state in which the frame 105 can reciprocate in the reciprocating direction. The guide rails 1063 are engaged with the back frame 1052. That is, the frame 105 on which the liquid discharge head 1 is mounted moves in the outward path direction OD or the homeward path direction HD along the head guide 1061 while being guided by the guide rails 1063 in accordance with the circulating movement of the timing belt 1062 in the outward path direction OD or the homeward path direction HD. The printer 10 is a so-called serial type printer that performs printing on a recording medium by discharging liquids while reciprocating the liquid discharge head 1 in the reciprocating direction.

The dryer 107 dries the printing paper P. After passing between the two guide rollers 102B, the printing paper P is dried by the dryer 107. By drying with the dryer 107, overlapped portions of the printing paper P wound around the collection roller 104 becomes less likely to be adhered to each other and undried liquid becomes less likely to be rubbed.

The sensor 108 includes a position sensor, a speed sensor, and a temperature sensor. The controller 109 can control each portion of the printer 10 based on the information from each sensor.

The printer 10 may include a cleaner that cleans the liquid discharge head 1. The cleaner cleans the liquid discharge head 1 by, for example, a wiping process or a capping process.

As the recording medium, in addition to the printing paper P, a roll of cloth or the like may be used. The printer 10 may convey the recording medium using a conveyance belt. With this configuration, a sheet of paper, cut cloth, wood, a tile, or the like can be used as the recording medium. By discharging a liquid containing electrically conductive particles from the liquid discharge head 1, for example, a wiring pattern of an electronic device may be printed. Chemicals may be fabricated by discharging a predetermined amount of a liquid chemical agent or a liquid containing a chemical agent from the liquid discharge head 1 toward a reaction vessel or the like and causing it to react.

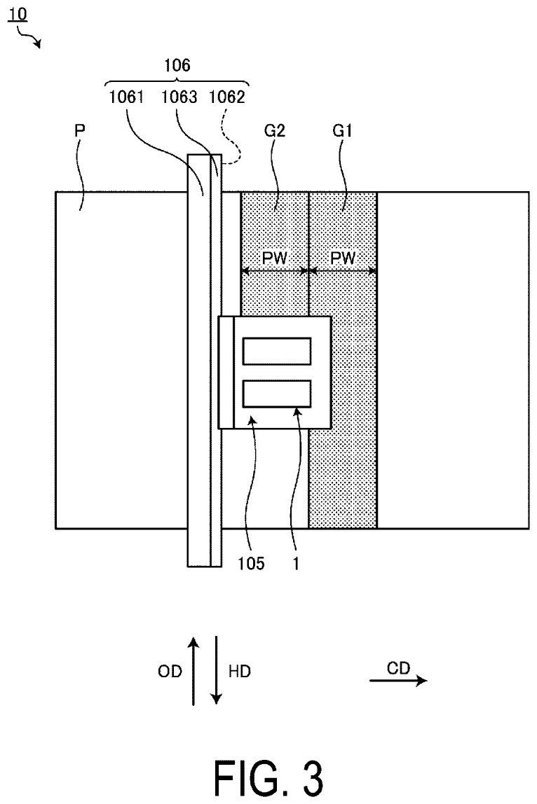

A printing method executed by the printer 10 according to the present embodiment will be described with reference to FIG. 3. FIG. 3 is a schematic diagram for explaining a serial printing method executed by the printer 10 according to the first embodiment. In FIG. 3, only the liquid discharge head 1, the frame 105, and the scanner 106 of the printer 10 are illustrated for easy understanding of the description. The printer 10 performs a printing process on the printing paper P by the serial printing method.

The serial printing method is a printing method in which reciprocating movement of the frame 105, on which the liquid discharge head 1 is mounted, in the outward path direction OD and the homeward path direction HD and intermittent feeding of the printing paper P in the conveying direction CD are repeated. Here, the liquid discharge head 1 has a predetermined printing width PW in the conveying direction CD.

FIG. 3 illustrates a state in which the liquid discharge head 1 has moved in the outward path direction OD and the printing of a band-like image G1 having the printing width PW has been completed. In printing in the outward path direction OD, the feeding of the printing paper P is stopped. After the printing of the band-like image G1, the printing paper P is fed in the conveying direction CD by a pitch corresponding to the printing width PW. At this time, the frame 105 on which the liquid discharge head 1 is mounted waits at an end portion of the printing paper P on the upper side of the scanner 106 in the drawing. After the printing paper P is fed out, the frame 105 turns back in the homeward path direction HD in accordance with the reversing movement of the timing belt 1062. In printing in the homeward path direction HD, the feeding of the printing paper P is stopped. The liquid discharge head 1 prints a band-like image G2 having the printing width PW on the left side of the band-like image G1 while moving in the homeward path direction HD. In this way, the printing in the outward path direction OD and the printing in the homeward path direction HD are alternately repeated. That is, the lower side of the scanner 106 in the drawing corresponds to a start point in the outward path and an end point in the homeward path. The upper side of the scanner 106 in the drawing corresponds to an end point in the outward path and a start point in the homeward path.

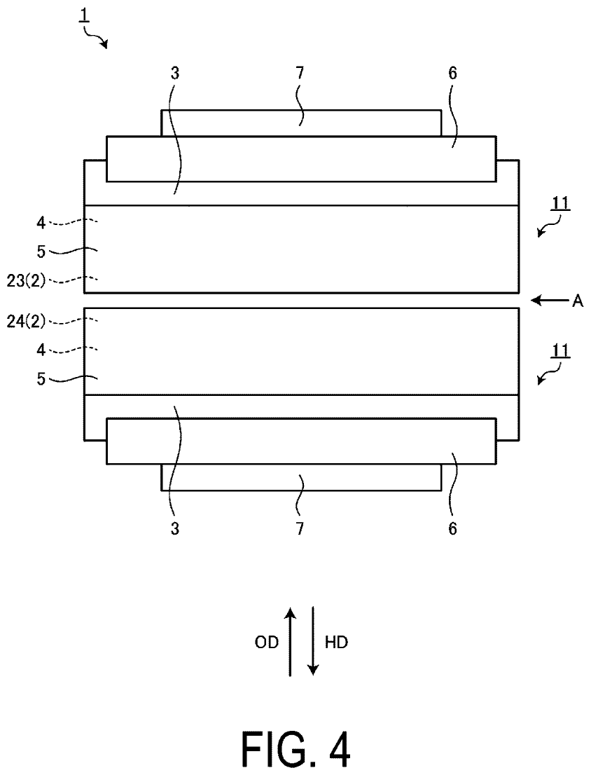

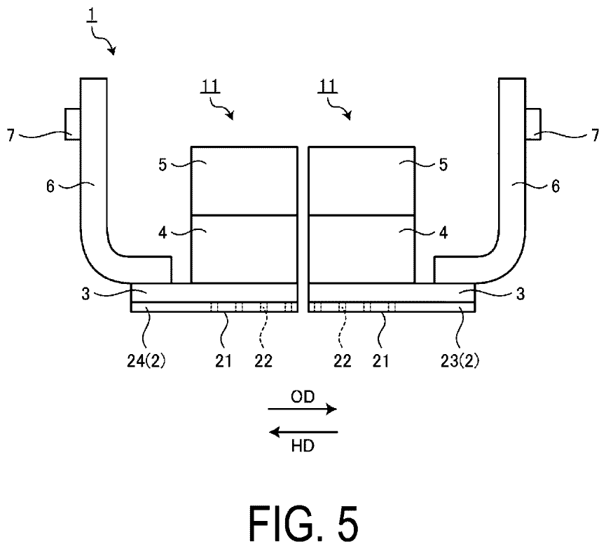

A configuration of the liquid discharge head 1 according to the present embodiment will be described with reference to FIGS. 4 and 5. FIG. 4 is a plan view schematically illustrating the liquid discharge head 1 according to the first embodiment. FIG. 5 is a side view of the liquid discharge head 1 illustrated in FIG. 4, as seen from a direction A. In the following description, viewing from the outward path direction OD means viewing the start point from the end point in the outward path. Viewing from the homeward path direction HD means viewing the start point from the end point in the homeward path. For example, in FIG. 4, viewing from the outward path direction OD means viewing the lower side from the upper side in the drawing, and viewing from the homeward path direction HD means viewing the upper side from the lower side in the drawing.

The liquid discharge head 1 includes two heads 11. The number of heads 11 included in the liquid discharge head 1 can be changed as appropriate. Each of the heads 11 includes a nozzle substrate 2, an actuator substrate 3, a support substrate 4, a liquid supply substrate 5, a flexible substrate 6, and a drive IC 7.

The nozzle substrate 2 includes a nozzle surface 21 and a plurality of nozzles 22 that open in the nozzle surface 21. The nozzle surface 21 is a lower surface of the nozzle substrate 2. The nozzles 22 are through holes penetrating the nozzle substrate 2 in the vertical direction. The liquid discharge head 1 according to the present embodiment includes two nozzle substrates 2. When viewed from the outward path direction OD, the first nozzle substrate 2 is referred to as a first chip 23, and the second nozzle substrate 2 is referred to as a second chip 24. The actuator substrate 3 is located on the nozzle substrate 2. When a pressure is applied to the liquids in the actuator substrate 3, the liquids are discharged from the respective nozzles 22 to the outside as droplets. The actuator substrate 3 according to the present embodiment has substantially the same shape as the nozzle substrate 2 in a plan view.

The support substrate 4 is located on the actuator substrate 3. The support substrate 4 supplies the liquids to the actuator substrate 3. The support substrate 4 has a predetermined thickness larger than the thickness of the actuator substrate 3 in the vertical direction, and has a function of supporting the actuator substrate 3. The support substrate 4 according to the present embodiment has a shape smaller than the nozzle substrate 2 and the actuator substrate 3 in a plan view.

The liquid supply substrate 5 is located on the support substrate 4. The liquid supply substrate 5 supplies the liquids to the support substrate 4. The liquid supply substrate 5 has a function of storing the liquids to be supplied to the support substrate 4. The liquid supply substrate 5 according to the present embodiment has substantially the same shape as the support substrate 4 in a plan view.

The flexible substrate 6 is located on one end portion of the actuator substrate 3 in the reciprocating direction. Specifically, in FIG. 4, the flexible substrate 6 of the head 11 including the first chip 23 is located on the end portion of the actuator substrate 3 on the upper side in the drawing, and the flexible substrate 6 of the head 11 including the second chip 24 is located on the end portion of the actuator substrate 3 on the lower side in the drawing. The head 11 according to the present embodiment includes one flexible substrate 6, but is not limited thereto. For example, the head 11 may include two or more flexible substrates 6. One end portion of the flexible substrate 6 is electrically connected to the actuator substrate 3, and another end portion of the flexible substrate 6 is drawn out above the support substrate 4. The flexible substrate 6 is a wiring substrate having flexibility and has a function of transmitting a drive signal to the actuator substrate 3.

The drive IC 7 is mounted on the flexible substrate 6. The drive IC 7 is electrically connected to the controller 109. Thus, the drive IC 7 generates a drive signal based on a signal transmitted from the controller 109. The drive IC 7 outputs the drive signal to the actuator substrate 3 via the flexible substrate 6. Accordingly, the drive IC 7 can control the driving of the liquid discharge head 1.

Note that FIGS. 4 and 5 illustrate an example of the configuration of the liquid discharge head 1, and the liquid discharge head 1 may further include a member other than the members illustrated in FIGS. 4 and 5. For example, the liquid discharge head 1 may include, in addition to the heads 11, a treatment head capable of discharging a treatment liquid for improving the fixability of the liquids to the printing paper P. In the liquid discharge head 1, any member of the heads 11 may be provided in common. For example, in the liquid discharge head 1, the liquid supply substrate 5 may be provided in common to the two heads 11.

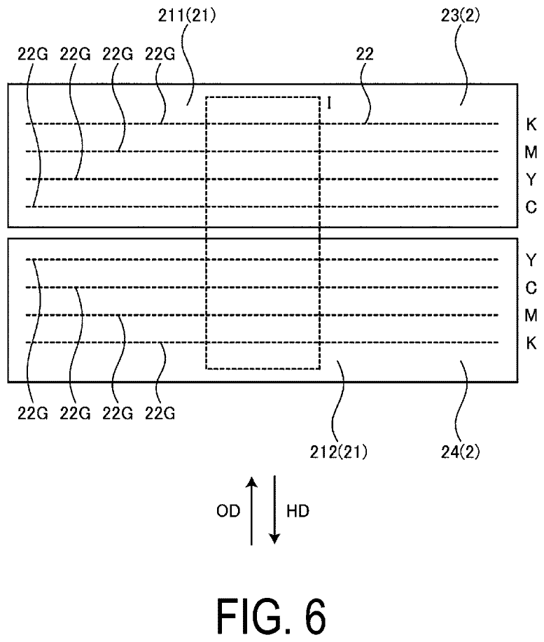

An outline of the arrangement of the nozzles 22 will be described with reference to FIG. 6. FIG. 6 is a plan view illustrating the nozzle surface 21 according to the first embodiment.

In the liquid discharge head 1, the plurality of nozzles 22 are provided to the nozzle surface 21. The nozzle surface 21 includes a first nozzle surface 211 provided to the first chip 23 and a second nozzle surface 212 provided to the second chip 24. The nozzle surface 21 according to the present embodiment includes two nozzle substrates 2, but is not limited thereto. The nozzle surface 21 may include only one nozzle substrate 2, or may include three or more nozzle substrates 2.

The plurality of nozzles 22 according to the present embodiment form eight nozzle groups 22G. The eight nozzle groups 22G are, for example, parallel to each other. The eight nozzle groups 22G have lengths same as, and/or similar to each other. In the liquid discharge head 1, the intervals between the nozzle groups 22G are substantially equal to each other except for the interval between the fourth nozzle group 22G and the fifth nozzle group 22G as viewed from the outward path direction OD. The interval between the fourth nozzle group 22G and the fifth nozzle group 22G as viewed from the outward path direction OD is larger than the intervals between the other nozzle groups 22G due to the size of the heads 11. The intervals between the nozzle groups 22G may be uniform or non-uniform.

Each of the plurality of nozzles 22 is capable of discharging a liquid of one color selected from among the liquids of four colors of magenta, cyan, black, and yellow. In the following description, magenta, cyan, black, and yellow are denoted by M, C, K and Y, respectively. The nozzles 22 capable of discharging the liquids of the same color are provided in each of the eight nozzle groups 22G. The colors of the liquids that can be discharged by the nozzles 22 of the first nozzle group 22G to the eighth nozzle group 22G when viewed from the outward path direction OD of the liquid discharge head 1 according to the present embodiment are K, M, Y, C, Y, C, M, and K. The order of the colors can be changed as appropriate. In FIG. 6, the colors of the liquids that can be discharged by the nozzles 22 of each of the nozzle groups 22G are indicated on the right side of each of the nozzle groups 22G in the drawing.

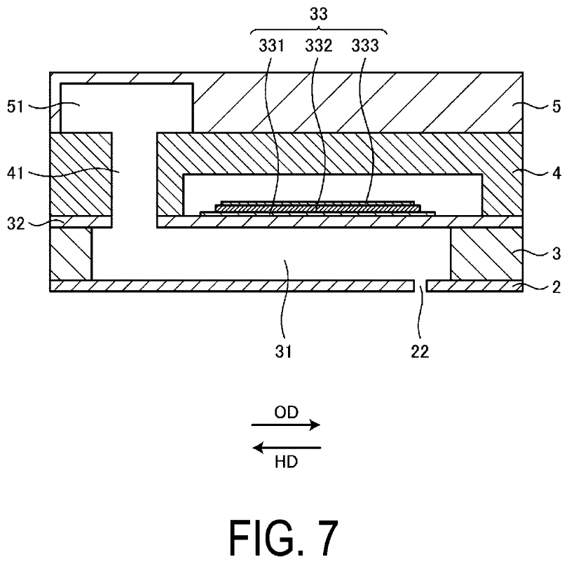

The internal structure of the liquid discharge head 1 according to the present embodiment will be described with reference to FIG. 7. FIG. 7 is a schematic cross-sectional view illustrating a part of the liquid discharge head 1 according to the first embodiment in an enlarged manner. The liquid discharge head 1 includes a plurality of piezoelectric elements 33 provided for each nozzle 22, and FIG. 7 illustrates one piezoelectric element 33.

The actuator substrate 3 includes a pressure chamber 31, a diaphragm 32, and a piezoelectric element 33.

The pressure chamber 31 communicates with the nozzle 22 in the nozzle substrate 2. The pressure chamber 31 is provided for each nozzle 22. A plurality of pressure chambers 31 are provided along the nozzle group 22G, and form a pressure chamber group. Since eight nozzle groups 22G according to the present embodiment are present, in the same or similar manner, eight pressure chamber groups are also formed. The pressure chamber 31 is filled with a liquid, and the liquid is supplied from a common flow path 51 of the liquid supply substrate 5 to the pressure chamber 31 via a connection flow path 41 in the support substrate 4. The common flow path 51 is formed along the pressure chamber group, and supplies the liquid to the plurality of pressure chambers 31 included in the pressure chamber group. Since eight pressure chamber groups according to the present embodiment are present, in the same or similar manner, eight common flow paths 51 are also formed. In the present embodiment, since the colors of the liquids that can be discharged by the nozzles 22 of the first nozzle group 22G to the eighth nozzle group 22G when viewed from the outward path direction OD are K, M, Y, C, Y, C, M, and K, the colors of the liquids flowing through the common flow paths 51 when viewed from the outward path direction OD are also K, M, Y, C, Y, C, M, and K.

The diaphragm 32 is provided over the plurality of pressure chambers 31. Examples of the constituent material of the diaphragm 32 include Si and SiO₂.

The piezoelectric element 33 is provided on the diaphragm 32 corresponding to the pressure chamber 31. The piezoelectric element 33 includes a common electrode 331, a piezoelectric body 332, and an individual electrode 333. In the piezoelectric element 33 according to the present embodiment, the common electrode 331 is located on the diaphragm 32 corresponding to the pressure chamber 31, the piezoelectric body 332 is located on the common electrode 331, and the individual electrode 333 is located on the piezoelectric body 332, but are not limited thereto. For example, the arrangement order of the common electrode 331 and the individual electrode 333 from the diaphragm 32 may be reversed. That is, the individual electrode 333, the piezoelectric body 332, and the common electrode 331 may be provided in this order on the diaphragm 32.

In the piezoelectric body 332, a portion sandwiched between the individual electrode 333 and the common electrode 331 is polarized in the vertical direction. Therefore, when a voltage is applied in the polarization direction of the piezoelectric body 332 by the individual electrode 333 and the common electrode 331, the piezoelectric body 332 contracts in a direction along the diaphragm 32. This contraction is regulated by the diaphragm 32. As a result, the piezoelectric body 332 is displaced to be convex toward the pressure chamber 31 side. With the displacement of the piezoelectric body 332, the diaphragm 32 located on the pressure chamber 31 is also displaced. As a result, a pressure is applied to the liquid in the pressure chamber 31. The thickness of the piezoelectric body 332 may be 1 μm or more and 10 μm or less. Examples of the constituent material of the piezoelectric body 332 include a ceramic material having ferroelectricity such as a Pb(Zr, Ti)O₃-based material, a NaNbO₃-based material, a BaTiO₃-based material, a (BiNa)NbO₃-based material, and a BiNaNB₅O₁₅-based material.

Thicknesses of the common electrode 331 and the individual electrode 333 may be set to 0.05 μm or more and 1 μm or less. Examples of the constituent material of the common electrode 331 and the individual electrode 333 include a metal material such as Pt.

The pressure chamber 31, the connection flow path 41 and the common flow path 51 are filled with the liquid. When a pressure is applied to the pressure chamber 31 by the piezoelectric element 33, the liquid is supplied from the pressure chamber 31 to the nozzle 22, and liquid droplets are discharged from the nozzle 22. The pressure chamber 31 is replenished with the liquid from the common flow path 51 via the connection flow path 41.

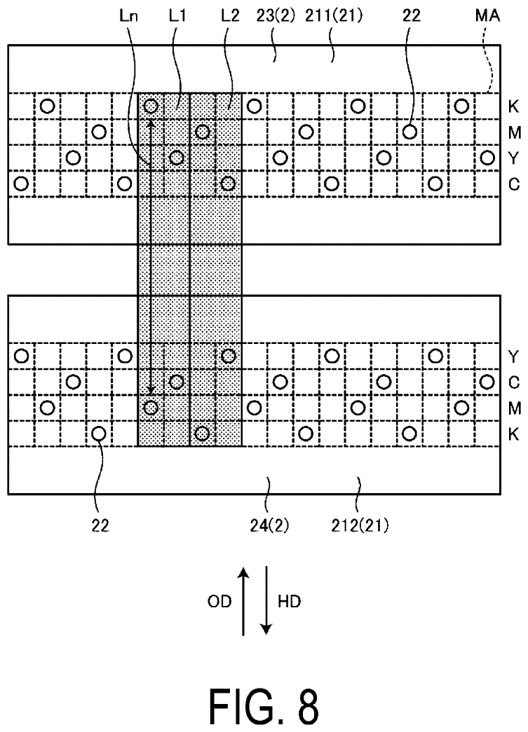

The arrangement of the nozzles 22 in the liquid discharge head 1 will be described with reference to FIG. 8. FIG. 8 is an enlarged view of a region I illustrated in FIG. 6.

In the liquid discharge head 1, when a region MA having a matrix-shape of 2m rows×n columns (m is an even number of 2 or more, and n is an integer of 4 or more) is assumed at the nozzle surface 21, the plurality of nozzles 22 are provided at predetermined locations in the region MA. In FIG. 8, the region MA is indicated by dotted lines. The dotted lines are interrupted at locations between the first nozzle surface 211 and the second nozzle surface 212, but the first nozzle surface 211 and the second nozzle surface 212 do not form two regions MA, but the nozzle surface 21 forms one region MA as a whole.

Since the region MA according to the present embodiment has eight rows (m=4), the plurality of nozzles 22 are provided in eight rows, and eight nozzle groups 22G are formed. In the liquid discharge head 1 according to the present embodiment, each row is along a direction orthogonal to the reciprocating direction. Each row may be along a direction intersecting the reciprocating direction. Since the nozzles 22 provided in the rows form the nozzle groups 22G, the nozzles 22 capable of discharging the liquids of the same color are provided in each of the eight rows, as the same as or similarly to the nozzle group 22G. The colors of the liquids that can be discharged by the nozzles 22 of the first row to the eighth row when viewed from the outward path direction OD of the liquid discharge head 1 according to the present embodiment are K, M, Y, C, Y, C, M, and K. In FIG. 8, the colors of the liquids that can be discharged by the nozzles 22 of the respective rows are indicated on the outside of the respective rows in the row direction. The indication of the colors of the liquids that can be discharged by the nozzles 22 of the rows is also presented in other drawings used in the description below.

Intervals between the nozzles 22 in each row are 84.6 μm. That is, the resolution of the nozzles 22 of each row is 300 dpi. The nozzles 22 in each row in the first nozzle surface 211 are shifted from the nozzles 22 in the other rows in the row direction, and the resolution of the nozzles 22 in all the four rows is 1200 dpi. In the same or similar manner, the resolution of the nozzles 22 in all the four rows in the second nozzle surface 212 is also 1200 dpi. The intervals between the nozzles 22 of each row may be set as appropriate.

Since the region MA according to the present embodiment has multiple columns, the plurality of nozzles 22 are provided in the multiple columns. The number of columns in the region MA may be set as appropriate, but in the present embodiment, the number of columns is 1000 or more and 10000 or less (n=1000 to 10000). In the liquid discharge head 1 according to the present embodiment, two nozzles 22 are provided in each of the multiple columns.

When respective two columns adjacent to each other in the row direction are defined as pixel columns, any one of the pixel columns is regarded as a first pixel column L1, and another of the pixel columns adjacent to the first pixel column L1 in the row direction is regarded as a second pixel column L2, the first pixel column L1 and the second pixel column L2 can respectively discharge the liquids of four types of colors from the four nozzles 22.

When viewed from the outward path direction OD, the order of the colors of the liquids that can be discharged by the four nozzles 22 included in the first pixel column L1 is K, Y, C, and M. When viewed from the outward path direction OD, the order of the colors of the liquids that can be discharged by the four nozzles 22 included in the second pixel column L2 is M, C, Y, and K.

In the liquid discharge head 1 according to the present embodiment, the liquids of four types of colors can be discharged by the four nozzles 22 included in a pixel column consisting of two columns adjacent to each other in the row direction. Therefore, a distance Ln between the nozzles 22 belonging to the same column is larger than that in a case in which the liquids of four types of colors can be discharged by the four nozzles 22 included in a pixel column consisting of one column. Since the distance Ln between the nozzles 22 belonging to the same column is larger, in the liquid discharge head 1, the possibility that a pressure applied one nozzle 22 at the time of discharging the liquid is transmitted to the other nozzle 22 adjacent to the one nozzle in the same column can be reduced. Since the possibility that a pressure applied to one nozzle 22 at the time of discharging the liquid is transmitted to the other nozzle 22 adjacent to the one nozzle in the same column can be reduced, in the liquid discharge head 1, the possibility that discharge characteristics of the liquids discharged from the adjacent nozzles 22 are affected can be reduced.

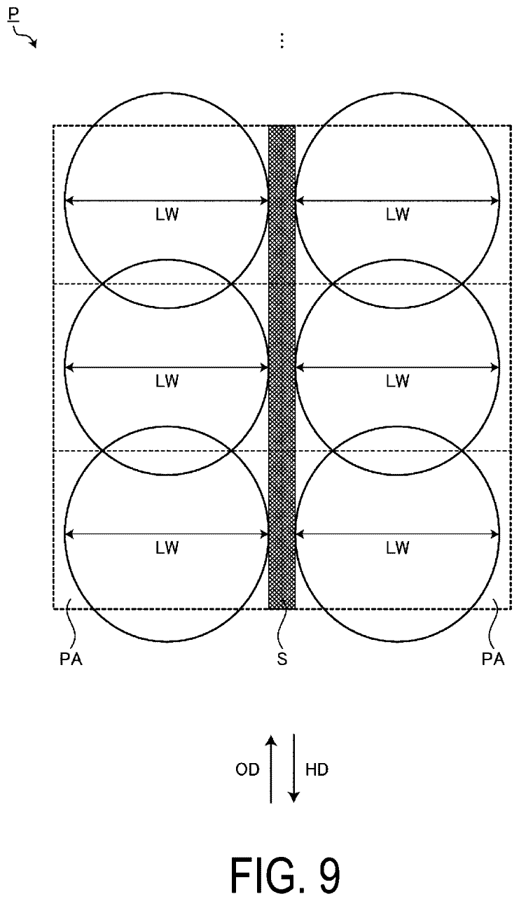

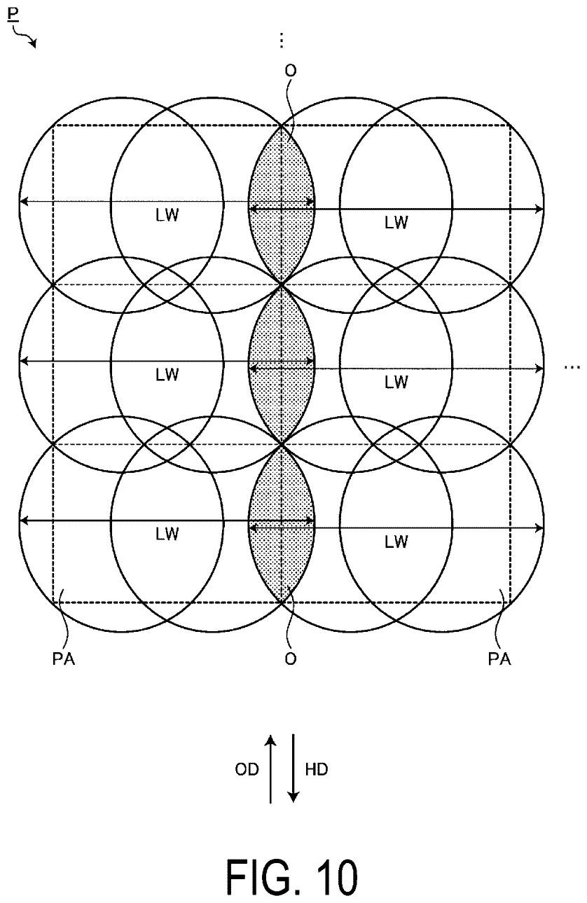

With reference to FIGS. 9 and 10, a description will be made on comparison between a printing state with a liquid discharge head (hereinafter, referred to as a first comparative head) capable of discharging liquids of four types of colors by the four nozzles 22 included in a pixel column consisting of one column and a printing state with the liquid discharge head 1 according to the present embodiment. FIG. 9 is a plan view schematically illustrating the liquids discharged to pixel regions PA adjacent to each other on the printing paper P by the first comparative head. FIG. 10 is a plan view schematically illustrating the liquids discharged to the pixel regions PA adjacent to each other on the printing paper P by the liquid discharge head 1 according to the first embodiment.

In FIGS. 9 and 10, the liquids discharged to the pixel regions PA are indicated by circles. As illustrated in FIG. 9, in the first comparative head, the liquids of four types of colors can be discharged by the four nozzles 22 included in the pixel column consisting of one column. Therefore, in one pixel region PA, the liquids of four types are discharged to one location in the row direction. That is, the liquids of four types are discharged to one circle in FIG. 9. On the other hand, in the liquid discharge head 1 according to the present embodiment, the liquids of four types of colors can be discharged by the four nozzles 22 included in the pixel column consisting of two columns adjacent to each other. Therefore, in one pixel region PA, the liquids of four types are discharged to two locations in the row direction. That is, the liquids of two types are discharged to one circle in FIG. 10.

Accordingly, in the liquid discharge head 1 according to the present embodiment, a width LW in the row direction of the liquids discharged to one pixel region PA on the printing paper P is larger than that of the first comparative head. In the liquid discharge head 1 according to the present embodiment, since the width LW in the row direction of the liquids discharged to one pixel region PA on the printing paper P is larger, the possibility that the liquids discharged to the pixel regions PA adjacent to each other overlap increases, or the possibility that an overlap O of the liquids is expanded increases. Therefore, in the liquid discharge head 1 according to the present embodiment, the possibility of the occurrence of, for example, a streak S as illustrated in FIG. 9, which is caused because the liquids discharged to the pixel regions PA adjacent to each other on the printing paper P do not overlap can be reduced.

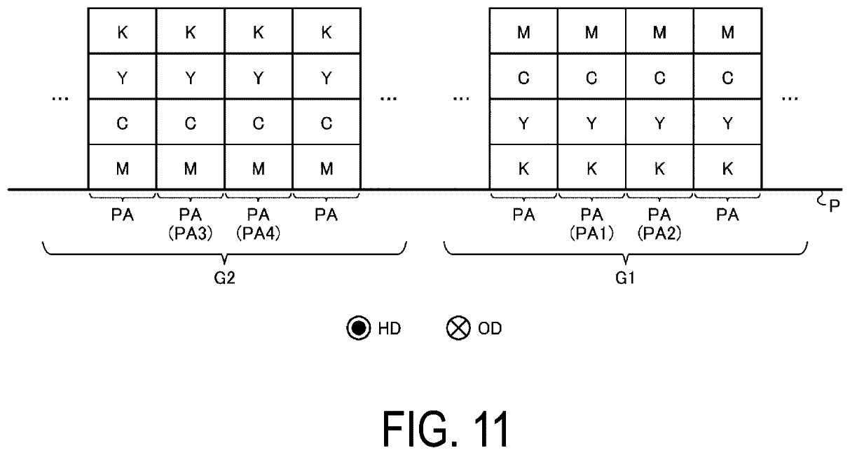

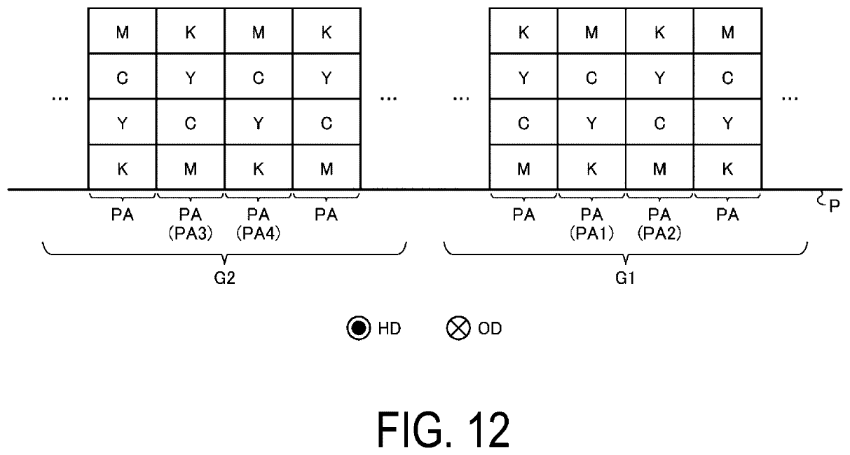

With reference to FIGS. 11 and 12, a description will be made on comparison between a printing state with a liquid discharge head (hereinafter, referred to as a “second comparative head”) in which the order of the colors of the liquids that can be discharged by the four nozzles 22 included in the first pixel column L1 is K, Y, C, and M and the order of the colors of the liquids that can be discharged by the four nozzles 22 included in the second pixel column L2 is also K, Y, C, and M when viewed from the outward path direction OD and a printing state with the liquid discharge head 1 according to the present embodiment.

FIG. 11 is a schematic diagram illustrating a state of the liquids discharged onto the printing paper P in the outward path and the homeward path by the second comparative head. FIG. 12 is a schematic diagram illustrating a state of the liquids discharged onto the printing paper P in the outward path and the homeward path by the liquid discharge head 1 according to the first embodiment. FIGS. 11 and 12 are diagrams illustrating a printing state of the band-like image G1 and a printing state of the band-like image G2 as viewed from the homeward path direction HD. In FIGS. 11 and 12, the liquids are illustrated as being sequentially layered on the printing paper P in order to facilitate the description of the order in which the liquids are discharged.

First, the printing state of the second comparative head will be described. In the outward path of the second comparative head, the liquids are layered in the order of K, Y, C, and M on a certain pixel region (hereinafter, referred to as a “first pixel region PA1”) on the printing paper P by the first pixel column L1. In a second pixel region PA2 adjacent to the first pixel region PA1 on the printing paper P, the liquids are layered in the order of K, Y, C, and M by the second pixel column L2. In the homeward path of the second comparative head, the liquids are layered in the order of M, C, Y, and K on a certain pixel region (hereinafter, referred to as a “third pixel region PA3”) on the printing paper P by the first pixel column L1. In a fourth pixel region PA4 adjacent to the third pixel region PA3, the liquids are layered in the order of M, C, Y, and K by the second pixel column L2.

In this way, in the second comparative head, the pixel regions PA in which the liquids are layered in the order of K, Y, C, and M are formed adjacent to each other on the printing paper P in the outward path, and the pixel regions PA in which the liquids are layered in the order of M, C, Y, and K are formed adjacent to each other on the printing paper P in the homeward path. Therefore, since the pixel regions PA in which the order of the colors of the liquids layered in the outward path is the same and the pixel regions PA in which the order of the colors of the liquids layered in the homeward path is the same are opposite in the order of the colors of the liquids layered to each other, color unevenness may occur in the second comparative head.

That is, since the pixel regions PA1 and PA2 in which the liquids are layered in the order of K, Y, C, and M are formed adjacent to each other on the printing paper P in the outward path, a person who checks the printing paper P visually recognizes an image in which the liquids are layered in the order of K, Y, C, and M. That is, when viewed by a person who checks the printing paper P, the liquid of M is located on the top layer, and thus an image in which M is emphasized is visually recognized. On the other hand, since the pixel regions PA3 and PA4 in which the liquids are layered in the order of M, C, Y, and K are formed adjacent to each other on the printing paper P in the homeward path, a person who checks the printing paper P visually recognizes an image in which the liquids are layered in the order of M, C, Y, and K. That is, when viewed by a person who checks the printing paper P, the liquid of K is located on the top layer, and thus an image in which K is emphasized is visually recognized. In this way, there is a possibility that color unevenness occurs between the outward path and the homeward path in the second comparative head.

In contrast, in the liquid discharge head 1 according to the present embodiment, the order of the colors of the liquids that can be discharged by the four nozzles 22 included in the first pixel column L1, that is, K, Y, C, and M, is opposite to the order of the colors of the liquids that can be discharged by the four nozzles 22 included in the second pixel column L2, that is, M, C, Y, and K, when viewed from the outward path direction OD. Therefore, in the outward path, the liquids are layered in the order of K, Y, C, and M in the first pixel region PA1 on the printing paper P by the first pixel column L1, and the liquids are layered in the order of M, C, Y, and K in the second pixel region PA2 by the second pixel column L2. On the other hand, in the homeward path, the liquids are layered in the order of M, C, Y, and K in the third pixel region PA3 by the first pixel column L1, and the liquids are layered in the order of K, Y, C, and M in the fourth pixel region PA4 by the second pixel column L2.

In this way, in the liquid discharge head 1 according to the present embodiment, in both the outward path and the homeward path, the pixel regions PA1 and PA4 in which the liquids are layered in the order of K, Y, C, and M and the pixel regions PA2 and PA3 in which the liquids are layered in the order of M, C, Y, and K can be formed adjacent to each other on the printing paper P, respectively. Therefore, since the pixel regions PA1 and PA2 which are opposite to each other in the order of the colors of the liquids layered in the outward path and the pixel regions PA3 and PA4 which are opposite to each other in the order of the colors of the liquids layered in the homeward path are the same in the order of the colors of the liquids layered, the possibility of occurrence of color unevenness can be reduced in the liquid discharge head 1 according to the present embodiment.

That is, on the printing paper P in the outward path, the pixel region PA1 in which the liquids are layered in the order of K, Y, C, and M and the pixel region PA2 in which the liquids are layered in the order of M, C, Y, and K are formed adjacent to each other.

Therefore, a person who checks the printing paper P visually recognizes the pixel region PA1 in which the liquids are layered in the order of K, Y, C, and M and the pixel region PA2 in which the liquids are layered in the order of M, C, Y, and K as an image in which these pixel regions are adjacent to each other. That is, when viewed by a person who checks the printing paper P, an image in which K and M are emphasized is visually recognized. On the other hand, on the printing paper P in the homeward path, the pixel region PA4 in which the liquids are layered in the order of K, Y, C, and M and the pixel region PA3 in which the liquids are layered in the order of M, C, Y, and K are formed adjacent to each other. Therefore, a person who checks the printing paper P visually recognizes the pixel region PA3 in which the liquids are layered in the order of M, C, Y, and K and the pixel region PA4 in which the liquids are layered in the order of K, Y, C, and M as an image in which these pixel regions are adjacent to each other. When viewed by a person who checks the printing paper P, an image in which K and M are emphasized is visually recognized, as the same as or similar to the outward path. In this way, in the liquid discharge head 1 according to the present embodiment, the possibility of occurrence of color unevenness can be reduced.

As described above, in the liquid discharge head 1 according to the present embodiment, the possibility of occurrence of the streak S can be reduced, and the possibility of occurrence of color unevenness can also be reduced.

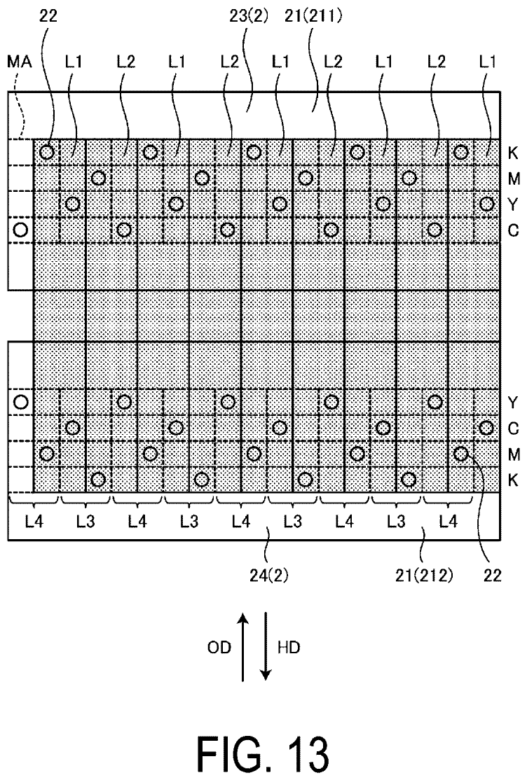

The arrangement of the nozzles 22 and the order of the colors of the liquids in the liquid discharge head 1 according to the present embodiment will be further described with reference to FIG. 13. FIG. 13 is an enlarged view of the region I illustrated in FIG. 6.

In the liquid discharge head 1 according to the present embodiment, the first pixel column L1 and the second pixel column L2 are repeatedly arranged adjacent to each other in the row direction. In the liquid discharge head 1, in both the outward path and the homeward path, the pixel regions PA which are opposite to each other in the order of the colors of the liquids layered can be formed adjacent to each other on the printing paper P. The pixel regions PA which are opposite to each other in the order of the colors of the liquids layered in the outward path and the pixel regions PA which are opposite to each other in the order of the colors of the liquids layered in the homeward path are the same in the order of the colors of the liquids layered. Further, these pixel regions PA can be repeatedly formed adjacent to each other in the row direction on the printing paper P. Therefore, in the liquid discharge head 1 according to the present embodiment, the possibility of occurrence of color unevenness can be further reduced.

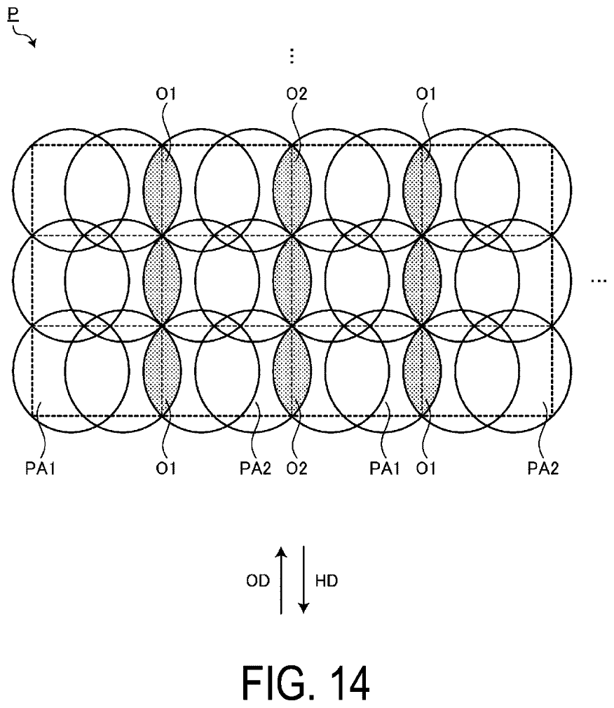

Overlapping of the liquids discharged by the liquid discharge head 1 will be further described with reference to FIG. 14 in addition to FIG. 13. FIG. 14 is a plan view schematically illustrating the liquids discharged onto the printing paper P by the liquid discharge head 1 according to the first embodiment.

In the liquid discharge head 1 according to the present embodiment, as described above, the liquids respectively discharged to the first pixel region PA1 and the second pixel region PA2 adjacent to each other on the printing paper P are highly likely to overlap.

Specifically, the liquids discharged from the nozzles 22 in the second column of the first pixel column L1 and the liquids discharged from the nozzles 22 in the first column of the second pixel column L2 overlap each other on the printing paper P. Here, a region in which the liquids overlap on the printing paper P is referred to as a first region O1. The liquids discharged from the nozzles 22 in the first column of the first pixel column L1 and the liquids discharged from the nozzles 22 in the second column of the second pixel column L2 also overlap each other on the printing paper P. Here, a region in which the liquids overlap on the printing paper P is referred to as a second region O2.

The third pixel column L3 consists of the second column of the first pixel column L1 and the first column of the second pixel column L2. The fourth pixel column LA consists of the second column of the second pixel column L2 and the first column of the first pixel column L1. Accordingly, the liquids are discharged to the first region O1 by the third pixel column L3, and the liquids are discharged to the second region 02 by the fourth pixel column L4. The third pixel column L3 and the fourth pixel column L4 each can discharge the liquid of four types of colors from the four nozzles 22, and are repeatedly arranged adjacent to each other in the row direction.

In the liquid discharge head 1, the order of the colors of the liquids that can be discharged by the four nozzles 22 included in the third pixel column L3, that is, M, Y, C, and K, is opposite to the order of the colors of the liquids that can be discharged by the four nozzles 22 included in the fourth pixel column L4, that is, K, C, Y, and M, when viewed from the outward path direction OD. Accordingly, in both the outward path and the homeward path, the first region O1 and the second region O2 which are opposite to each other in the order of the colors of the liquids layered can be formed adjacent to each other on the printing paper P. Since the first region O1 and the second region O2 which are opposite to each other in the order of the colors of the liquids layered in the outward path and the first region O1 and the second region 02 which are opposite to each other in the order of the colors of the liquids layered in the homeward path are the same in the order of the colors of the liquids layered, the possibility of occurrence of color unevenness can be further reduced in the liquid discharge head 1.

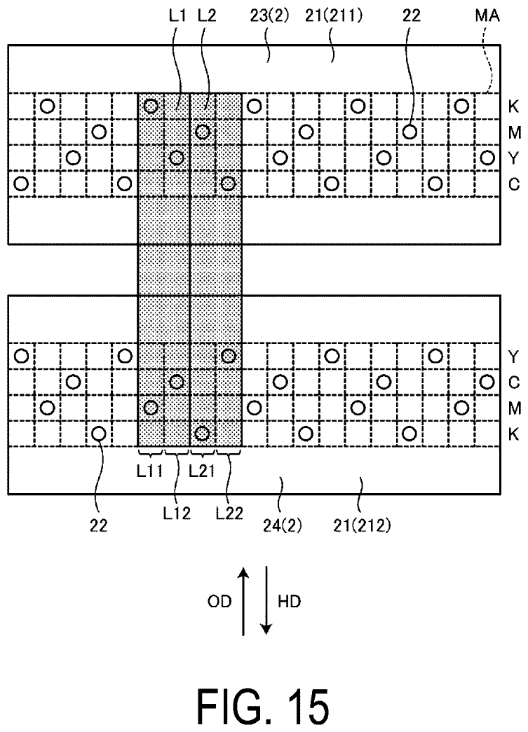

The arrangement of the nozzles 22 and the colors of the liquids that can be discharged by the nozzles 22 included in the rows and the columns in the liquid discharge head 1 according to the present embodiment will be further described with reference to FIG. 15. FIG. 15 is an enlarged view of the region I illustrated in FIG. 6.

In the liquid discharge head 1, the liquids of two types of colors among the liquids of four types of colors are the liquids of Y and K, and each of the multiple columns includes one nozzle 22 out of the nozzle 22 capable of discharging the liquid of Y and the nozzle 22 capable of discharging the liquid of K, and does not include the other nozzle 22. The liquid discharge head 1 according to the present embodiment includes columns in which the nozzle 22 capable of discharging the liquid of Y and the nozzle 22 capable of discharging the liquid of C are provided, and columns in which the nozzle 22 capable of discharging the liquid of K and the nozzle 22 capable of discharging the liquid of M are provided.

Here, when the liquids of the colors other than K are mixed with the liquid of K, the hues of the liquids are greatly changed. In particular, the liquid of Y has a larger change in hue when mixed with the liquid of K than the liquids of C and M. If the liquid discharge head 1 includes both the nozzle 22 capable of discharging the liquid of Y and the nozzle 22 capable of discharging the liquid of K in the same column, as the liquid discharge head 1 reciprocates in a direction intersecting the row direction, the liquid of K leaking from the nozzle 22 may move in the reciprocating direction and reach the nozzle 22 capable of discharging the liquid of Y. When the liquid of Y is discharged onto the printing paper P, the liquid of Y may be mixed with the liquid of K that has reached the nozzle 22, and thus the hue of the discharged liquid of Y may change, and the printing quality may be deteriorated.

In contrast, in the liquid discharge head 1 according to the present embodiment, each of the multiple columns includes one nozzle 22 out of the nozzle 22 capable of discharging the liquid of Y and the nozzle 22 capable of discharging the liquid of K, and does not include the other nozzle 22. Accordingly, even when the liquid discharge head 1 reciprocates in the direction intersecting the row direction, the possibility that the liquid of K leaking from the nozzle 22 reaches the nozzle 22 capable of discharging the liquid of Y can be reduced.

Therefore, the liquid discharge head 1 can reduce the possibility of deterioration in the printing quality due to a change in the hue of the liquid of Y when the liquid of Y is discharged onto the printing paper P and mixed with the liquid of K that has reached the nozzle 22.

When the liquids of C, M, and Y are mixed with the liquid of K, the hues of the liquids of C, M, and Y are greatly changed. Here, when the nozzle 22 capable of discharging the liquid of K is provided in any of the second to seventh rows when viewed from the outward path direction OD, a row in which the nozzle 22 capable of discharging the liquid of C, M, or Y is present on either side in a column direction of the row in which the nozzle 22 capable of discharging the liquid of K is provided. Accordingly, along with the reciprocation in the direction intersecting the row direction, the liquid of K leaking from the nozzle 22 may reach the nozzle 22 capable of discharging the liquid of C, M, or Y. For example, when the color of the liquid that can be discharged by the nozzle 22 provided in the third row when viewed from the outward path direction OD is K, there is a possibility that the liquid of K reaches the nozzle 22 provided in the second row and capable of discharging the liquid of M and the nozzle 22 provided in the fourth row and capable of discharging the liquid of C.

Therefore, when the liquid of M or C is discharged onto the printing paper P and mixed with the liquid of K that has reached the nozzle 22 capable of discharging the liquid of M or C, the hue of the discharged liquid of M or C may change, and the printing quality may be deteriorated.

In contrast, in the liquid discharge head 1 according to the present embodiment, the nozzle 22 capable of discharging the liquid of K is provided in the first row and the eighth row when viewed from the outward path direction OD. Therefore, a row in which the nozzle 22 capable of discharging the liquid of M is present on one side in the column direction of the row in which the nozzle 22 capable of discharging the liquid of K is provided, and no row in which the nozzle 22 capable of discharging the liquid of C, M, or Y is provided is present on the other side. Therefore, the liquid discharge head 1 according to the present embodiment can reduce the possibility of deterioration in the printing quality due to a change in the hue of the liquid of C, M, or Y when the liquid of C, M, or Y is discharged onto the printing paper P and mixed with the liquid of K that has reached the nozzle 22. Since a change in the hue of the liquid of M when mixed with the liquid of K is smaller than a change in the hue of the liquids of C and Y, in the liquid discharge head 1 according to the present embodiment, the color of the liquids that can be discharged by the nozzles 22 in the second row and the seventh row, which the liquid of K is likely to reach, is set to M.

In the liquid discharge head 1, the rows may be inclined with respect to a direction perpendicular to the reciprocating direction. In the liquid discharge head 1, the rows may be accidentally inclined with respect to the direction perpendicular to the reciprocating direction. In that case, while the nozzles 22 located on the inner side in the reciprocating direction are less likely to be affected by the inclination, the nozzles 22 located on the outer side are likely to be affected by the inclination. For example, the liquids discharged from the nozzles 22 in the fourth row and the fifth row when viewed from the outward path direction OD are landed without being shifted so much from landing positions assumed at the time without inclination. On the other hand, the liquids discharged from the nozzles 22 in the first row and the eighth row when viewed from the outward path direction OD are landed so as to be shifted from landing positions assumed at the time without inclination.

For two colors of Y and C, the influence of the inclination will be described for a liquid discharge head (hereinafter, referred to as a “third comparative head”) in which the order of the colors of the liquids that can be discharged by the nozzles 22 in the first row to the fourth row when viewed from the outward path direction OD and the order of the colors of the liquids that can be discharged by the nozzles 22 in the first row to the fourth row when viewed from the homeward path direction HD are the same as Y and C. In the third comparative head, the distance between the rows including the nozzles 22 capable of discharging the liquid of Y is larger than the distance between the rows including the nozzles 22 capable of discharging the liquid of C. Accordingly, in the third comparative head, the nozzles 22 capable of discharging the liquid of Y are likely to be affected by the inclination, and the nozzles 22 capable of discharging the liquid of C are less likely to be affected by the inclination. Therefore, in the third comparative head, since the influence of the inclination is different between the nozzles 22 capable of discharging the liquid of Y and the nozzles 22 capable of discharging the liquid of C, the printing quality may be deteriorated.

On the other hand, in the liquid discharge head 1 according to the present embodiment, the order of the colors of the liquids that can be discharged by the nozzles 22 in the first row to the fourth row when viewed from the outward path direction OD and the order of the colors of the liquids that can be discharged by the nozzles 22 in the first row to the fourth row when viewed from the homeward path direction HD are opposite to each other as for two colors of Y and C. Specifically, for the two colors of Y and C, the order of the colors of the liquids that can be discharged by the nozzles 22 in the first row to the fourth row when viewed from the outward path direction OD is Y and C, and the order of the colors of the liquids that can be discharged by the nozzles 22 in the first row to the fourth row when viewed from the homeward path direction HD is C and Y. Therefore, in the liquid discharge head 1, the distance between the rows including the nozzles 22 capable of discharging the liquid of Y and the distance between the rows including the nozzles 22 capable of discharging the liquid of C can be made equal, as compared with the third comparative head. Therefore, in the liquid discharge head 1, since the nozzles 22 capable of discharging the liquid of Y and the nozzles 22 capable of discharging the liquid of C are affected by the inclination in the same and/or similar manner, the possibility of deterioration of the printing quality can be reduced.

The colors of the liquids that can be discharged by the nozzles 22 of the first row to the eighth row when viewed from the outward path direction OD of the liquid discharge head 1 according to the present embodiment may be K, M, Y, C, K, M, Y, and C. That is, in the liquid discharge head 1, for four colors of K, M, Y, and C, the order of the colors of the liquids that can be discharged by the nozzles 22 in the first row to the fourth row when viewed from the outward path direction OD and the order of the colors of the liquids that can be discharged by the nozzles 22 in the first row to the fourth row when viewed from the homeward path direction HD are opposite to each other. In this liquid discharge head 1, the distance between the rows including the nozzles 22 capable of discharging the same color can be made substantially equal for any color. Therefore, in this liquid discharge head 1, since the nozzles 22 capable of discharging the liquids of any colors are affected by the inclination in the same or similar manner, the possibility of deterioration of the printing quality can be further reduced.

As described above, in the liquid discharge head 1 according to the present embodiment, the first row and the eighth row when viewed from the outward path direction OD include the nozzles 22 capable of discharging the liquid of K. In the liquid discharge head 1 according to the present embodiment, the fourth row and the fifth row when viewed from the outward path direction OD may include the nozzles 22 capable of discharging the liquid of K. In this liquid discharge head 1, for example, in a case of performing monochrome printing, the nozzles 22 capable of discharging the liquid of K are less likely to be affected by the inclination, and thus the possibility of deterioration of the printing quality can be reduced.

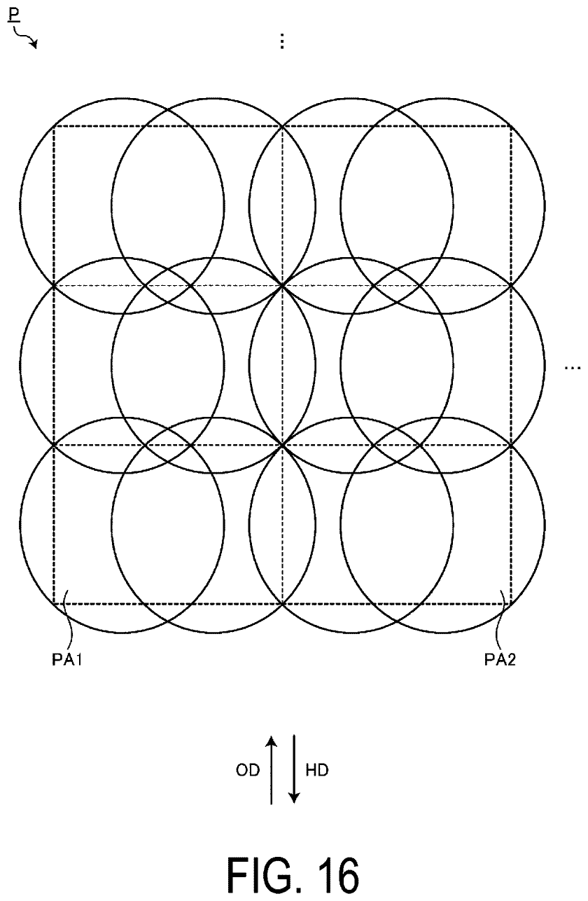

The relationship between the first pixel region PA1 and the second pixel region PA2 to which the liquids are discharged by the liquid discharge head 1 will be described with reference to FIG. 16 in addition to FIG. 15. FIG. 16 is a plan view schematically illustrating the liquids discharged onto the printing paper P by the liquid discharge head 1. In the description of the liquids discharged onto the printing paper P, the leftward direction in the drawing of FIG. 16 is referred to as one side in the row direction, and the rightward direction in the drawing of FIG. 16 is referred to as the other side in the row direction.

In the first pixel region PA1, the liquids are discharged from the nozzles 22 in the first column L11 of the first pixel column L1 on the one side in the row direction, and the liquids are discharged from the nozzles 22 in the second column L12 of the first pixel column L1 on the other side in the row direction. In the second pixel region PA2, the liquids are discharged from the nozzles 22 in the first column L21 of the second pixel column L2 on the one side in the row direction, and the liquids are discharged from the nozzles 22 in the second column L22 of the second pixel column L2 on the other side in the row direction.

In the liquid discharge head 1 according to the present embodiment, the nozzles 22 capable of discharging the liquids of K and M are provided in the first column L11 of the first pixel column L1 and the first column L21 of the second pixel column L2. In the liquid discharge head 1 according to the present embodiment, the nozzles 22 capable of discharging the liquids of Y and C are provided in the second column L12 of the first pixel column L1 and the second column L22 of the second pixel column L2.

That is, in the liquid discharge head 1 according to the present embodiment, the nozzles 22 capable of discharging the liquids of the same colors are provided in the first column L11 of the first pixel column L1 and the first column L21 of the second pixel column L2, and the nozzles 22 capable of discharging the liquids of the same colors are also provided in the second column L12 of the first pixel column L1 and the second column L22 of the second pixel column L2. Therefore, in the liquid discharge head 1 according to the present embodiment, since the liquids of the same colors are discharged to the same positions in the row direction in the first pixel region PA1 and the second pixel region PA2, the possibility of occurrence of color unevenness between the first pixel region PA1 and the second pixel region PA2 can be reduced.

As described above, the resolution of the nozzles 22 in all the four rows in the first nozzle surface 211 and the second nozzle surface 212 is 1200 dpi. Since one nozzle 22 of the first nozzle surface 211 and one nozzle 22 of the second nozzle surface 212 are provided in each of the multiple columns, the resolution of the nozzles 22 in all the eight rows is also 1200 dpi. In the liquid discharge head 1 according to the present embodiment, the nozzles 22 capable of discharging the liquids of the same colors are provided in the first column L11 of the first pixel column L1 and the first column L21 of the second pixel column L2, and the nozzles 22 capable of discharging the liquids of the same colors are also provided in the second column L12 of the first pixel column L1 and the second column L22 of the second pixel column L2, and thus the resolution of the nozzles 22 capable of discharging the liquids of the same colors is 600 dpi.

In the liquid discharge head 1 according to the present embodiment, when viewed from the outward path direction OD, the nozzles 22 are provided in the first row and the seventh row of the first column L11 of the first pixel column L1, the nozzles 22 are provided in the third row and the sixth row of the second column L12 of the first pixel column L1, the nozzles 22 are provided in the second row and the eighth row of the first column L21 of the second pixel column L2, and the nozzles 22 are provided in the fourth row and the fifth row of the second column L22 of the second pixel column L2.

That is, in the liquid discharge head 1 according to the present embodiment, the nozzles 22 are provided in the order of the first column L11, the second column L12, the second column L12, and the first column L11 of the first pixel column L1 when viewed from the outward path direction OD. In the second pixel column L2, the nozzles 22 are provided in the order of the first column L21, the second column L22, the second column L22, and the first column L21 of the second pixel column L2 when viewed from the outward path direction OD. Therefore, when the order of the colors of the liquids that can be discharged from the four nozzles 22 included in the first pixel column L1 is opposite to the order of the colors of the liquids that can be discharged from the four nozzles 22 included in the second pixel column L2 when viewed from the outward path direction OD, the nozzles 22 that can discharge the liquids of the same colors can be provided in the same columns of the first pixel column L1 and the second pixel column L2. Therefore, in the liquid discharge head 1 according to the present embodiment, since the liquids of the same colors are discharged to the same positions in the row direction in the first pixel region PA1 and the second pixel region PA2, the possibility of occurrence of color unevenness between the first pixel region PA1 and the second pixel region PA2 can be reduced.

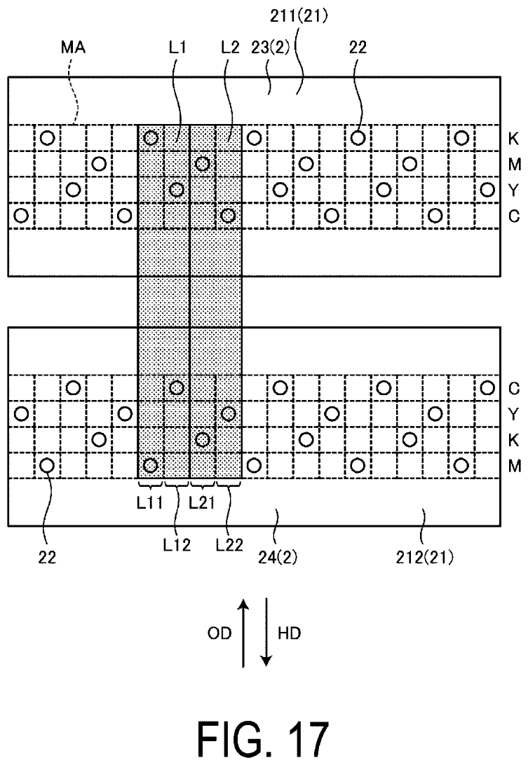

FIG. 17 is a plan view illustrating another example of the nozzle surface 21 according to the first embodiment. In the liquid discharge head 1, as illustrated in FIG. 17, when viewed from the outward path direction OD, the nozzles 22 are provided in the first row and the eighth row of the first column L11 of the first pixel column L1, the nozzles 22 are provided in the third row and the fifth row of the second column L12 of the first pixel column L1, the nozzles 22 are provided in the second row and the seventh row of the first column L21 of the second pixel column L2, and the nozzles 22 are provided in the fourth row and the sixth row of the second column L22 of the second pixel column L2.

In this liquid discharge head 1, the nozzles 22 are provided in the order of the first column L11, the second column L12, the second column L12, and the first column L11 of the first pixel column L1 when viewed from the outward path direction OD. In the second pixel column L2, the nozzles 22 are provided in the order of the first column L21, the second column L22, the second column L22, and the first column L21 of the second pixel column L2 when viewed from the outward path direction OD. Therefore, when the order of the colors of the liquids that can be discharged from the four nozzles 22 included in the first pixel column L1 is opposite to the order of the colors of the liquids that can be discharged from the four nozzles 22 included in the second pixel column L2 when viewed from the outward path direction OD, the nozzles 22 that can discharge the liquids of the same colors can be provided in the same columns of the first pixel column L1 and the second pixel column L2. Therefore, in this liquid discharge head 1, since the liquids of the same colors are discharged to the same positions in the row direction in the first pixel region PA1 and the second pixel region PA2, the possibility of occurrence of color unevenness between the first pixel region PA1 and the second pixel region PA2 can be reduced.

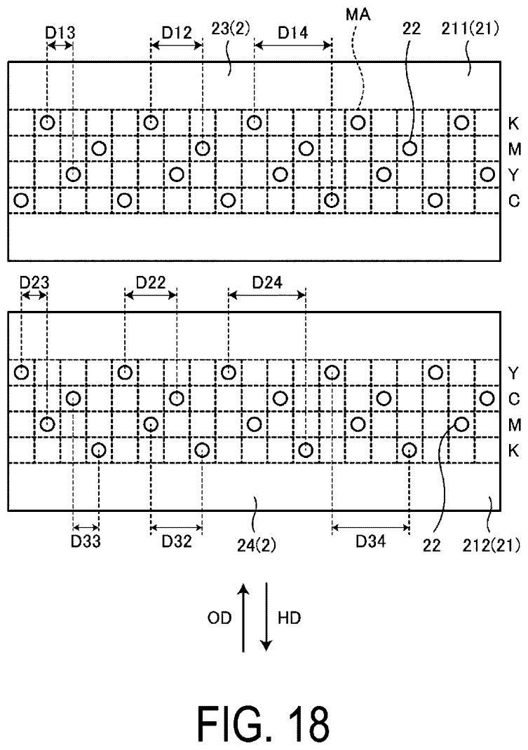

The relationship between the arrangements of the nozzles 22 of the first nozzle surface 211 and the second nozzle surface 212 according to the present embodiment will be described with reference to FIG. 18. FIG. 18 is an enlarged view of the region I illustrated in FIG. 6.

In the liquid discharge head 1 according to the present embodiment, the first nozzle surface 211 is provided with the plurality of nozzles 22 in the first row to the m-th row when viewed from the outward path direction OD. The second nozzle surface 212 is provided with the plurality of nozzles 22 in the first row to the m-th row when viewed from the homeward path direction HD. That is, since the first chip 23 including the first nozzle surface 211 and the second chip 24 including the second nozzle surface 212 are physically-separated members, the possibility that a pressure applied to the nozzles 22 provided to the first nozzle surface 211 or the second nozzle surface 212, which is the nozzle surface 21 of one chip, is transmitted to the nozzles 22 provided to the nozzle surface 21 of the other chip at the time of discharging the liquids can be reduced. Since the possibility that the pressure is transmitted to the nozzles 22 provided to the nozzle surface 21 of the other chip, the liquid discharge head 1 according to the present embodiment can reduce the possibility that the discharge characteristics of the liquids discharged from the nozzles 22 provided to the nozzle surface 21 of the other chip are affected.

In the liquid discharge head 1 according to the present embodiment, in the first nozzle surface 211 viewed from the outward path direction OD, a shift amount D12 in the row direction between the nozzles 22 in the first row and the second row is two columns, a shift amount D13 in the row direction between the nozzles 22 in the first row and the third row is one column, and a shift amount D14 in the row direction between the nozzles 22 in the first row and the fourth row is three columns. In the liquid discharge head 1 according to the present embodiment, in the second nozzle surface 212 viewed from the outward path direction OD, a shift amount D22 in the row direction between the nozzles 22 in the first row and the second row is two columns, a shift amount D23 in the row direction between the nozzles 22 in the first row and the third row is one column, and a shift amount D24 in the row direction between the nozzles 22 in the first row and the fourth row is three columns. That is, in the liquid discharge head 1 according to the present embodiment, the shift amount in the row direction between the nozzles 22 in the first row and another row in the first nozzle surface 211 viewed from the outward path direction OD is equal to the shift amount in the row direction between the nozzles 22 in the first row and a row having the same row number as the other row in the second nozzle surface 212 viewed from the outward path direction OD.

That is, the arrangement relationship of the nozzles 22 is the same or similar between the first nozzle surface 211 and the second nozzle surface 212, and the discharge characteristics of the nozzles 22 of the first nozzle surface 211 and the discharge characteristics of the nozzles 22 of the second nozzle surface 212 can be easily equalized.

Since the arrangement relationship of the nozzles 22 is the same or similar between the first nozzle surface 211 and the second nozzle surface 212, for example, manufacturing time and effort can be reduced by simply manufacturing chips without manufacturing a chip for the first chip 23 or manufacturing a chip for the second chip 24. A user does not need to manage the first chip 23 and the second chip 24 separately, and the management time and effort of the user can be reduced.

In the liquid discharge head 1 according to the present embodiment, in the second nozzle surface 212 viewed from the homeward path direction HD, a shift amount D32 in the row direction between the nozzles 22 in the first row and the second row is two columns, a shift amount D33 in the row direction between the nozzles 22 in the first row and the third row is one column, and a shift amount D34 in the row direction between the nozzles 22 in the first row and the fourth row is three columns. That is, in the liquid discharge head 1 according to the present embodiment, the shift amount in the row direction between the nozzles 22 in the first row and another row in the first nozzle surface 211 viewed from the outward path direction OD is equal to the shift amount in the row direction between the nozzles 22 in the first row and a row having the same row number as the other row in the second nozzle surface 212 viewed from the homeward path direction HD.

Therefore, the second chip 24 has a configuration in which the first chip 23 is rotated by 180 degrees about a direction orthogonal to the row direction and the column direction as a rotation axis. Here, the direction orthogonal to the row direction and the column direction is a direction perpendicular to the paper surface of the drawing of FIG. 18. In arranging the first chip 23 and the second chip 24, for example, chips that can be used as both the first chip 23 and the second chip 24 may be manufactured, and the chips may be arranged in a positional relationship in which the chips are rotated by 180 degrees with respect to each other.

Therefore, for example, there is no need to manufacture a chip for the first chip 23 or manufacture a chip for the second chip 24, and thus, the manufacturing time and effort can be reduced. A user does not need to manage the first chip 23 and the second chip 24 separately, and the management time and effort of the user can be reduced.

A manufacturing method of the liquid discharge head 1 will be described.

First, the nozzle substrate 2, the actuator substrate 3, the support substrate 4, the liquid supply substrate 5, the flexible substrate 6, and the drive IC 7 are prepared. The actuator substrate 3 is bonded onto the nozzle substrate 2, and the support substrate 4 is bonded onto the actuator substrate 3. The liquid supply substrate 5 is bonded onto the support substrate 4. The flexible substrate 6 on which the drive IC 7 is mounted is bonded to an end portion of the actuator substrate 3. Here, examples of a bonding method of the substrates include a method in which the substrates are bonded to each other by being pressurized while being heated in a vacuum. Examples of a bonding method of the actuator substrate 3 and the flexible substrate 6 include a bonding method using an adhesive.

In the foregoing, an example in which the flexible substrate 6 is bonded to the actuator substrate 3 after the liquid supply substrate 5 is bonded onto the support substrate 4 has been described, but the manufacturing method is not limited thereto. The liquid supply substrate 5 may be bonded onto the support substrate 4 after the flexible substrate 6 is bonded to the actuator substrate 3. That is, the order of bonding is not limited at all.

A manufacturing method of the actuator substrate 3 will be described. The actuator substrate 3 can be manufactured by sequentially forming and etching various films on a silicon wafer.

The diaphragm 32 is formed by forming a film of SiO₂ on a surface of a silicon wafer, for example, by a plasma CVD method.

The common electrode 331 is formed on the diaphragm 32 by, for example, forming a film of Pt by sputtering and then removing unnecessary portions by etching.

The piezoelectric body 332 is formed on the common electrode 331, for example, by forming a film of Pb(Zr, Ti)O₃ by a sol-gel method and then removing unnecessary portions by etching.

The individual electrode 333 is formed on the piezoelectric body 332, for example, by forming a film of Pt by sputtering and then removing unnecessary portions by etching.

The pressure chamber 31 is formed, for example, by etching a silicon wafer.

In this way, the actuator substrate 3 is manufactured.

A manufacturing method of the nozzle substrate 2 will be described.

For the nozzle substrate 2, a silicon wafer having a thickness smaller than the thickness of the actuator substrate 3 is used. Two chips each having the nozzle surface 21 are made of this silicon wafer, the nozzle surface 21 being provided with the nozzles 22 such that the shift amount D12 in the row direction of the nozzle 22 in the second row with respect to the nozzle 22 in the first row is two columns, the shift amount D13 in the row direction of the nozzle 22 in the third row with respect to the nozzle 22 in the first row is one column, and the shift amount D14 in the row direction of the nozzle 22 in the fourth row with respect to the nozzle 22 in the first row is three columns. One of the chips is arranged so as to be shifted by one column in the row direction from the other of the chips. The nozzles 22 can be formed by etching the silicon wafer.

In this way, the nozzle substrate 2 is manufactured.

### Second Embodiment

A liquid discharge head 1a according to a second embodiment will be described. In the description of the liquid discharge head la according to the present embodiment, basically, only differences from the liquid discharge head 1 according to the first embodiment will be described. Matters not specifically described may be assumed to be the same as, and/or similar to, or inferred from the first embodiment. The same or similar applies to a third embodiment to be described below.

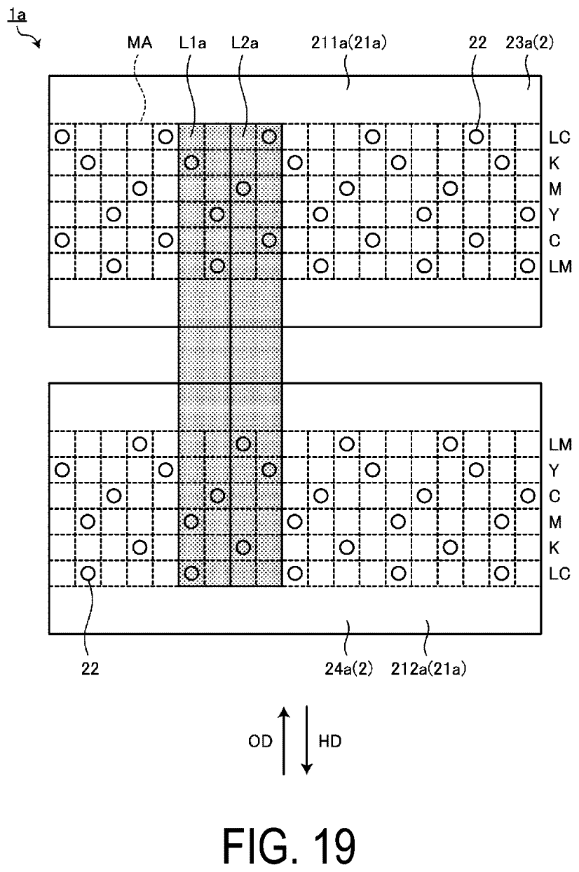

FIG. 19 is a plan view illustrating a part of a nozzle surface 21a according to the second embodiment in an enlarged manner. FIG. 19 corresponds to an enlarged view of the region I in FIG. 6. The nozzle surface 21a includes a first nozzle surface 211a provided to a first chip 23a and a second nozzle surface 212a provided to a second chip 24a.

Each of the plurality of nozzles 22 is capable of discharging a liquid of one color selected from among liquids of six colors of magenta, cyan, black, yellow, light cyan, and light black. Here, the six colors may be pigment black, dye black, cyan, magenta, yellow, and gray. In the following description, magenta, cyan, black, yellow, light cyan, and light black are denoted by M, C, K, Y, LC, and LM, respectively.

Since the region MA according to the present embodiment has twelve rows (m=6), the plurality of nozzles 22 are provided in the twelve rows (m=6). The nozzles 22 capable of discharging the liquids of the same colors are provided in each of the twelve rows. The colors of the liquids that can be discharged by the nozzles 22 of the first row to the twelfth row when viewed from the outward path direction OD of the liquid discharge head 1a according to the present embodiment are LC, K, M, Y, C, LM, LM, Y, C, M, K, and LC. Since the region MA according to the present embodiment has multiple columns, the plurality of nozzles 22 are provided in the multiple columns. Each of the multiple columns is provided with three nozzles 22.

Each of a first pixel column L1a and a second pixel column L2a can discharge the liquids of six types of colors from the six nozzles 22. In the liquid discharge head 1a according to the present embodiment, the liquids of six types of colors can be discharged by the six nozzles 22 included in a pixel column including two columns adjacent to each other. Accordingly, in the liquid discharge head 1a according to the present embodiment, the width LW in the row direction of the liquids discharged to one pixel region PA on the printing paper P (recording medium) is larger than that in a case in which the liquids of six types of colors can be discharged by the six nozzles 22 included in a pixel column including one column.

Since the width LW in the row direction of the liquids discharged to one pixel region PA on the printing paper P is larger, in the liquid discharge head 1a, the possibility that the liquids discharged to the pixel regions PA adjacent to each other overlap increases, or the possibility that the overlap O of the liquids is expanded increases. Therefore, in the liquid discharge head la according to the present embodiment, the possibility of the occurrence of a streak S which is caused because the liquids discharged to the pixel regions PA adjacent to each other on the printing paper P do not overlap can be reduced.

In the liquid discharge head la according to the present embodiment, the order of the colors of the liquids that can be discharged by the six nozzles 22 included in the first pixel column L1a, that is, K, Y, LM, C, M, and LC, is opposite to the order of the colors of the liquids that can be discharged by the six nozzles 22 included in the second pixel column L2a, that is, LC, M, C, LM, Y, and K, when viewed from the outward path direction OD. Therefore, in both the outward path and the homeward path of the liquid discharge head la, the pixel regions PA which are opposite to each other in the order of the colors of the liquids layered can be formed adjacent to each other on the printing paper P. The pixel regions PA which are opposite to each other in the order of the colors of the liquids layered in the outward path of the liquid discharge head 1a and the pixel regions PA which are opposite to each other in the order of the colors of the liquids layered in the homeward path of the liquid discharge head 1a are the same in the order of the colors layered. Therefore, in the liquid discharge head la, the possibility of occurrence of color unevenness can be reduced.

### Third Embodiment

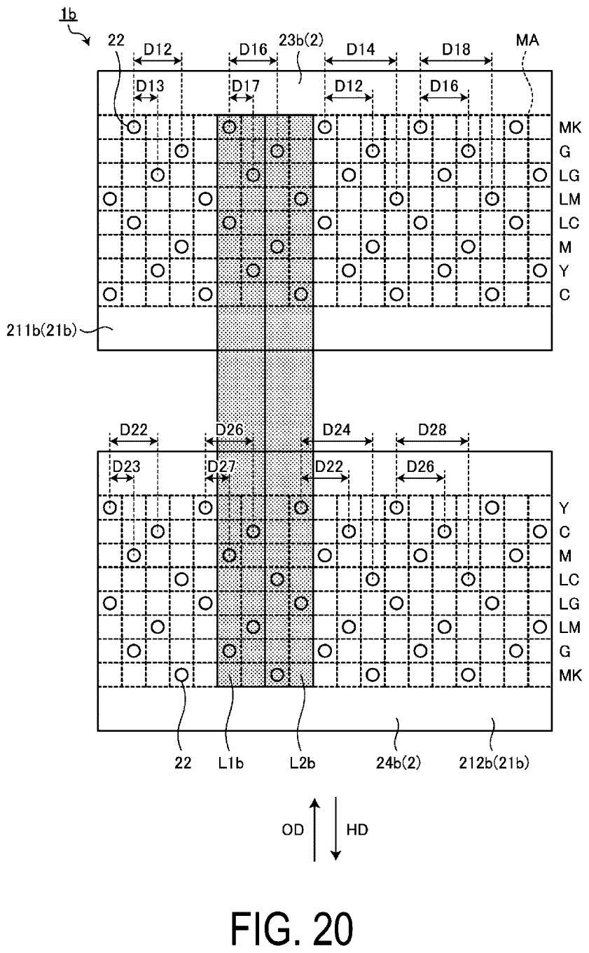

A liquid discharge head 1b according to a third embodiment will be described. FIG. 20 is a plan view illustrating a part of a nozzle surface 21b according to the third embodiment in an enlarged manner. FIG. 20 corresponds to an enlarged view of the region I in FIG. 6. The nozzle surface 21b includes a first nozzle surface 211b provided to a first chip 23b and a second nozzle surface 212b provided to a second chip 24b.

Each of the plurality of nozzles 22 is capable of discharging a liquid of one color selected from among liquids of eight colors of magenta, cyan, matte black, yellow, light cyan, light magenta, gray, and light gray. In the following description, magenta, cyan, matte black, yellow, light cyan, light magenta, gray, and light gray are denoted by M, C, MK, Y, LC, LM, G, and LG, respectively.

Since the region MA according to the present embodiment has sixteen rows (m=8), the plurality of nozzles 22 are provided in the sixteen rows. The nozzles 22 capable of discharging the liquids of the same colors are provided in each of the sixteen rows. The colors of the liquids that can be discharged by the nozzles 22 of the first row to the sixteenth row when viewed from the outward path direction OD of the liquid discharge head 1b according to the present embodiment are MK, G, LG, LM, LC, M, Y, C, Y, C, M, LC, LG, LM, G, and MK. Since the region MA according to the present embodiment has multiple columns, the plurality of nozzles 22 are provided in the multiple columns. Each of the multiple columns is provided with four nozzles 22.

Each of a first pixel column L1b and a second pixel column L2b can discharge the liquids of eight types of colors from the eight nozzles 22. In the liquid discharge head 1b according to the present embodiment, the liquids of eight types of colors can be discharged by the eight nozzles 22 included in a pixel column including two columns adjacent to each other. Accordingly, in the liquid discharge head 1b according to the present embodiment, the width LW in the row direction of the liquids discharged to one pixel region PA on the printing paper P (recording medium) is larger than that in a case in which the liquids of eight types of colors can be discharged by the eight nozzles 22 included in a pixel column including one column. Since the width LW in the row direction of the liquids discharged to one pixel region PA on the printing paper P is larger, in the liquid discharge head 1b, the possibility that the liquids discharged to the pixel regions PA adjacent to each other overlap increases, or the possibility that the overlap O of the liquids is expanded increases. Therefore, in the liquid discharge head 1b according to the present embodiment, the possibility of the occurrence of a streak S which is caused because the liquids discharged to the pixel regions PA adjacent to each other on the printing paper P do not overlap can be reduced.

In the liquid discharge head 1b according to the present embodiment, the order of the colors of the liquids that can be discharged by the eight nozzles 22 included in the first pixel column L1b, that is, MK, LG, LC, Y, C, M, LM, G, is opposite to the order of the colors of the liquids that can be discharged by the eight nozzles 22 included in the second pixel column L2b, that is, G, LM, M, C, Y, LC, LG, and MK, when viewed from the outward path direction OD. Therefore, in both the outward path and the homeward path of the liquid discharge head 1b, the pixel regions PA which are opposite to each other in the order of the colors of the liquids layered can be formed adjacent to each other on the printing paper P. The pixel regions PA which are opposite to each other in the order of the colors of the liquids layered in the outward path of the liquid discharge head 1b and the pixel regions PA which are opposite to each other in the order of the colors of the liquids layered in the homeward path of the liquid discharge head 1b are the same in the order of the colors layered. Therefore, in the liquid discharge head 1b, the possibility of occurrence of color unevenness can be reduced.

In the liquid discharge head 1b according to the present embodiment, in the first nozzle surface 211b viewed from the outward path direction OD, the shift amount D12 in the row direction between the nozzles 22 in the first row and the second row is two columns, the shift amount D13 in the row direction between the nozzles 22 in the first row and the third row is one column, and the shift amount D14 in the row direction between the nozzles 22 in the first row and the fourth row is three columns. In the first nozzle surface 211b viewed from the outward path direction OD, the nozzles 22 in the first row and the fifth row are not shifted in the row direction. In the first nozzle surface 211b viewed from the outward path direction OD, a shift amount D16 in the row direction between the nozzles 22 in the first row and the sixth row is two columns, a shift amount D17 in the row direction between the nozzles 22 in the first row and the seventh row is one column, and a shift amount D18 in the row direction between the nozzles 22 in the first row and the eighth row is three columns.

In the liquid discharge head 1b according to the present embodiment, in the second nozzle surface 212b viewed from the outward path direction OD, the shift amount D22 in the row direction between the nozzles 22 in the first row and the second row is two columns, the shift amount D23 in the row direction between the nozzles 22 in the first row and the third row is one column, and the shift amount D24 in the row direction between the nozzles 22 in the first row and the fourth row is three columns. In the second nozzle surface 212b viewed from the outward path direction OD, the nozzles 22 in the first row and the fifth row are not shifted in the row direction. In the second nozzle surface 212b viewed from the outward path direction OD, a shift amount D26 in the row direction between the nozzles 22 in the first row and the sixth row is two columns, a shift amount D27 in the row direction between the nozzles 22 in the first row and the seventh row is one column, and a shift amount D28 in the row direction between the nozzles 22 in the first row and the eighth row is three columns.

That is, in the liquid discharge head 1b according to the present embodiment, the shift amount in the row direction between the nozzles 22 in the first row and another row in the first nozzle surface 211b viewed from the outward path direction OD is equal to the shift amount in the row direction between the nozzles 22 in the first row and a row having the same row number as the other row in the second nozzle surface 212b viewed from the outward path direction OD. That is, the arrangement relationship of the nozzles 22 is the same or similar between the first nozzle surface 211b and the second nozzle surface 212b, and the discharge characteristics of the nozzles 22 of the first nozzle surface 211b and the discharge characteristics of the nozzles 22 of the second nozzle surface 212b can be easily equalized.

Since the arrangement relationship of the nozzles 22 is the same or similar between the first nozzle surface 211b and the second nozzle surface 212b, for example, manufacturing time and effort can be reduced by simply manufacturing chips without manufacturing a chip for the first chip 23b or manufacturing a chip for the second chip 24b. A user does not need to manage the first chip 23b and the second chip 24b separately, and the management time and effort of the user can be reduced.

The liquid discharge head 1b according to the present embodiment is composed of two chips, but may be composed of four chips. For example, the liquid discharge head 1b may be formed such that the nozzles 22 in the first row to the fourth row as viewed from the outward path are provided to a third nozzle surface of a third chip, the nozzles 22 in the fifth row to the eighth row are provided to a fourth nozzle surface of a fourth chip, the nozzles 22 in the ninth row to the twelfth row are provided to a fifth nozzle surface of a fifth chip, and the nozzles 22 in the thirteenth row to the sixteenth row are provided to a sixth nozzle surface of a sixth chip. That is, in the liquid discharge head 1b, the shift amount in the row direction between the nozzles 22 in the first row and another row in the third nozzle surface viewed from the outward path direction may be equal to the shift amount in the row direction between the nozzles 22 in the first row and a row having the same row number as the other row in the fourth nozzle surface, the fifth nozzle surface, and the sixth nozzle surface viewed from the outward path direction OD. That is, the arrangement relationship of the nozzles 22 in the third nozzle surface, the fourth nozzle surface, the fifth nozzle surface, and the sixth nozzle surface can be made the same or similar, and the discharge characteristics of the nozzles 22 in the third nozzle surface, the fourth nozzle surface, the fifth nozzle surface, and the sixth nozzle surface can be easily equalized. Manufacturing time and effort can also be reduced. A user does not need to manage the third chip, the fourth chip, the fifth chip, and the sixth chip separately, and the management time and effort of the user can also be reduced.

Note that the first to third embodiments described above may be combined as appropriate.

Additional effects and other aspects can be easily derived by a person skilled in the art. Thus, a wide variety of aspects of the present disclosure are not limited to the specific details and representative embodiments represented and described above. Accordingly, various changes are possible without departing from the spirit or scope of the general inventive concepts defined by the appended claims and their equivalents.

1. A liquid discharge head comprising:
a plurality of nozzles provided at predetermined locations in a region of a nozzle surface, the region being assumed to be a matrix-shaped region of 2m rows×n columns (m is an even number of 2 or more, and n is an integer of 4 or more), the liquid discharge head being configured to perform printing on a recording medium by reciprocating in a direction intersecting a row direction while discharging liquids from the plurality of nozzles in an outward path and a homeward path, wherein
each of the plurality of nozzles is configured to discharge a liquid of one color selected from among the liquids of m types of colors,
each of the 2m rows is provided with the plurality of nozzles configured to discharge the liquids of an identical color,
the n columns are provided with m/2 pieces of the plurality of nozzles,
when respective two of the columns adjacent to each other in the row direction are defined as pixel columns, and any one of the pixel columns is regarded as a first pixel column and another of the pixel columns adjacent to the first pixel column in the row direction is regarded as a second pixel column, then each of the first pixel column and the second pixel column is configured to discharge the liquids of m types of colors from m pieces of the plurality of nozzles, and
when viewed from a direction of the outward path, an order of colors of the liquids dischargeable from the m pieces of the plurality of nozzles comprised in the first pixel column is opposite to an order of colors of the liquids dischargeable from the m pieces of the plurality of nozzles comprised in the second pixel column.

2. The liquid discharge head according to claim 1, wherein
the n is an integer of 8 or more, and
the first pixel column and the second pixel column are repeatedly arranged adjacent to each other in the row direction.

3. The liquid discharge head according to claim 2, wherein
when one of the pixel columns shifted by one of the columns in the row direction from the first pixel column is regarded as a third pixel column and another of the pixel columns adjacent to the third pixel column in the row direction is regarded as a fourth pixel column, then each of the third pixel column and the fourth pixel column is configured to discharge the liquids of the m types of colors from the m pieces of the plurality of nozzles and repeatedly arranged adjacent to each other in the row direction, and
when viewed from the direction of the outward path, an order of colors of the liquids dischargeable from the m pieces of the plurality of nozzles comprised in the third pixel column is opposite to an order of colors of the liquids dischargeable from the m pieces of the plurality of nozzles comprised in the fourth pixel column.

4. The liquid discharge head according to claim 1, wherein
the liquids of two types of colors among the liquids of the m types of colors are a liquid of yellow and a liquid of black, and
each of the n columns comprises one of the nozzle configured to discharge the liquid of yellow and the nozzle configured to discharge the liquid of black, and does not comprise another nozzle.

5. The liquid discharge head according to claim 1, wherein
the plurality of nozzles configured to discharge the liquids of black are provided in a first row and a 2m-th row when viewed from the direction of the outward path.

6. The liquid discharge head according to claim 1, wherein
for any two colors, an order of the colors of the liquids dischargeable by the plurality of nozzles in first to m-th rows when viewed from the direction of the outward path is opposite to an order of the colors of the liquids dischargeable by the plurality of nozzles in first to m-th rows when viewed from a direction of the homeward path.

7. The liquid discharge head according to claim 1, wherein
the plurality of nozzles configured to discharge the liquids of black are provided in a m-th row and a (m+1)-th row when viewed from the direction of the outward path.

8. The liquid discharge head according to claim 1, wherein
the plurality of nozzles configured to discharge the liquids of an identical color are provided in a first column of the first pixel column and a first column of the second pixel column, and
the plurality of nozzles configured to discharge the liquids of an identical color are also provided in a second column of the first pixel column and a second column of the second pixel column.

9. The liquid discharge head according to claim 1, wherein
the m is four, and
when viewed from the direction of the outward path,
the plurality of nozzles are provided in a first row and a seventh row of a first column of the first pixel column,
the plurality of nozzles are provided in a third row and a sixth row of a second column of the first pixel column,
the plurality of nozzles are provided in a second row and an eighth row of a first column of the second pixel column, and
the plurality of nozzles are provided in a fourth row and a fifth row of a second column of the second pixel column.

10. The liquid discharge head according to claim 1, wherein
the m is four, and
when viewed from the direction of the outward path,
the plurality of nozzles are provided in a first row and an eighth row of a first column of the first pixel column,
the plurality of nozzles are provided in a third row and a fifth row of a second column of the first pixel column,
the plurality of nozzles are provided in a second row and a seventh row of a first column of the second pixel column, and
the plurality of nozzles are provided in a fourth row and an eighth row of a second column of the second pixel column.

11. The liquid discharge head according to claim 1, further comprising:
a first chip having a first nozzle surface; and
a second chip having a second nozzle surface, wherein
the nozzle surface comprises the first nozzle surface and the second nozzle surface,
the plurality of nozzles are provided in first to m-th rows at the first nozzle surface when viewed from the direction of the outward path, and
the plurality of nozzles are provided in first to m-th rows at the second nozzle surface when viewed from a direction of the homeward path.

12. The liquid discharge head according to claim 11, wherein
a shift amount in the row direction between the plurality of nozzles in the first row and another row in the first nozzle surface viewed from the direction of the outward path is equal to a shift amount in the row direction between the plurality of nozzles in the first row and a row having a row number identical to the other row in the second nozzle surface viewed from the direction of the outward path.

13. The liquid discharge head according to claim 11, wherein
a shift amount in the row direction between the plurality of nozzles in the first row and another row in the first nozzle surface viewed from the direction of the outward path is equal to a shift amount in the row direction between the plurality of nozzles in the first row and a row having a row number identical to the other row in the second nozzle surface viewed from the direction of the homeward path.

14. A recording device comprising:
the liquid discharge head according to claim 1;
a scanner configured to reciprocate the liquid discharge head in the direction of the outward path and the direction of the homeward path; and
a controller configured to control the scanner.
